(19) United States
(12) Patent Application Publication
(10) Pub. No.: US 2009/0271110 A1
(43) Pub. Date: Oct. 29, 2009

(54) Local time amendment method and navigation apparatus

(75) Inventor: Wataru Sugiura, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/385,686

(22) Filed: Apr. 16, 2009

(30) Foreign Application Priority Data
Apr. 25, 2008 (JP) 2008-115334

(51) Int. Cl. G01C 21/00; G04C 11/02; G04B 47/00

(52) U.S. Cl. 701/208; 368/47; 368/13; 701/207; 368/14

(57) ABSTRACT

In a local time amendment system, a navigation apparatus has a clock section to count a clock time (UTC, Universal Time Coordinated) in units of hours, minutes, and seconds based on an atomic clock of a GPS Satellite. In contrast, a cellular phone acquires information on local time wirelessly via a base station, which is connected to a mobile radio communication network. The information on local time signifies a local time of each administrative area, for instance, a country, state, city, etc. The navigation apparatus acquires data in units of hours indicated by an internal clock section of the cellular phone to thereby amend the clock time counted by the clock section with respect to the units of hours to thereby amend the clock time, which is indicated by the clock section, to the local time accurate with respect to units of hours in addition to units of minutes and seconds.

### CROSS REFERENCE TO RELATED APPLICATION

This application is based on and incorporates herein by reference Japanese Patent Application No. 2008-115334 filed on Apr. 25, 2008.

### FIELD OF THE INVENTION

The present invention relates to a local time amendment method or navigation apparatus, which is used for travel movement between areas, which have a time difference or daylight saving time.

### BACKGROUND OF THE INVENTION

Patent document 1: JP 2000-187088 A (Corresponding to EP1014235)

Travel movement across borders between countries, e.g., when traveling abroad, or travel movement between states within one country like Australia or the United States of America may undergo a time difference in an area of a movement destination (referred to a movement destination area). Patent document 1 discloses a local time amendment method to automatically amend a clock time of a clock apparatus to a local time used in the movement destination area.

In the local time amendment method, a radio wave, namely, a GPS signal, sent from a satellite for GPS (Global Positioning System) is received. Position information and UTC information, which is information on Universal Time Coordinated, are obtained from the received signal and used for referring to a clock time count table, which indicates a time difference (i.e., a clock time coefficient) from the UTC with respect to each area. Thereby, an amendment process is performed to add a time coefficient according to a present position of the clock apparatus to the UTC.

Incidentally, in the mainland of U.S., a three-hour time difference is present between West Coast and East Coast, and four standard time zones are present. The borderlines of the time zones do not necessarily match those of states; yet further, with respect to the daylight saving time, there is a state, for example, the State of Indiana, to include an area to adopt the daylight saving time and an area not to adopt it.

Thus, when applied to a country, for instance, the United States of America, which has complicated borderlines for time zones or daylight saving time, the conventional local time amendment method is executed as follows. In the clock time count table, a time coefficient needs to be associated with each position coordinates of longitude and latitude instead of states or countries; further, the clock time coefficient needs to be updated according to the enforcement of the daylight saving time, thus posing a problem to require an additional work to prepare it. Furthermore, it is said that a clock time count table is required in addition to the existing clock apparatus, primarily posing a burden or complicating the amendment process.

### SUMMARY OF THE INVENTION

It is an object of the present invention to provide (i) a local time amendment method to automatically amend a clock time using a simple configuration and process, and (ii) a navigation apparatus to automatically amend a clock time by a process using the existing apparatus configuration.

According to an example of the present invention, a method is provided for amending a local time in a clock apparatus that counts a clock time based on information on hour, minute, and second included in a signal received from a satellite for a global positioning system. The method comprises: acquiring hour unit data representing, in units of hours, a clock time of a movement destination area indicated by an internal clock of a receiver, which has acquired a local time of a travel movement destination area by receiving a control signal, which is transmitted to the travel movement destination area; and amending, in units of hours, the clock time counted by the clock apparatus based on the acquired hour unit data to thereby amend the clock time, which is counted by the clock apparatus, to the local time of the travel movement destination area.

According to another example of the present invention, a navigation apparatus is provided as follows. The navigation apparatus is mounted in a vehicle and communicates with a cellular phone. The navigation apparatus includes the following. A reception section is configured to receive a signal transmitted from a satellite for a global positioning system. A clock section is configured to count a clock time based on information on hours, minutes, and seconds included in the signal received by the reception section. An hour unit data acquisition portion is configured to acquire, at a predetermined acquisition time point, hour unit data representing in units of hours a clock time indicated by an internal clock of the cellular phone, which previously acquires a local time of a travel movement destination area wirelessly from a base station connected to a mobile radio communication network. An amendment portion is configured to amend, in units of hours, the clock time counted by the clock section based on the hour unit data acquired by the hour unit data acquisition portion.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating an overall configuration of a local time amendment system using a local time amendment method according to an embodiment of the present invention;

FIG. 2 is a block diagram illustrating an overall configuration of a cellular phone according to the embodiment;

FIG. 3 is a block diagram illustrating an overall configuration of a navigation apparatus according to the embodiment; and

FIG. 4 is a flowchart diagram to illustrate a local time amendment process by a control section of the navigation apparatus.

### DETAILED DESCRIPTION OF THE PREFERRED EMBODIMENTS

Hereinafter, description will be given to an embodiment of the present invention with reference to the drawings.

### <Configuration of Local Time Amendment System>

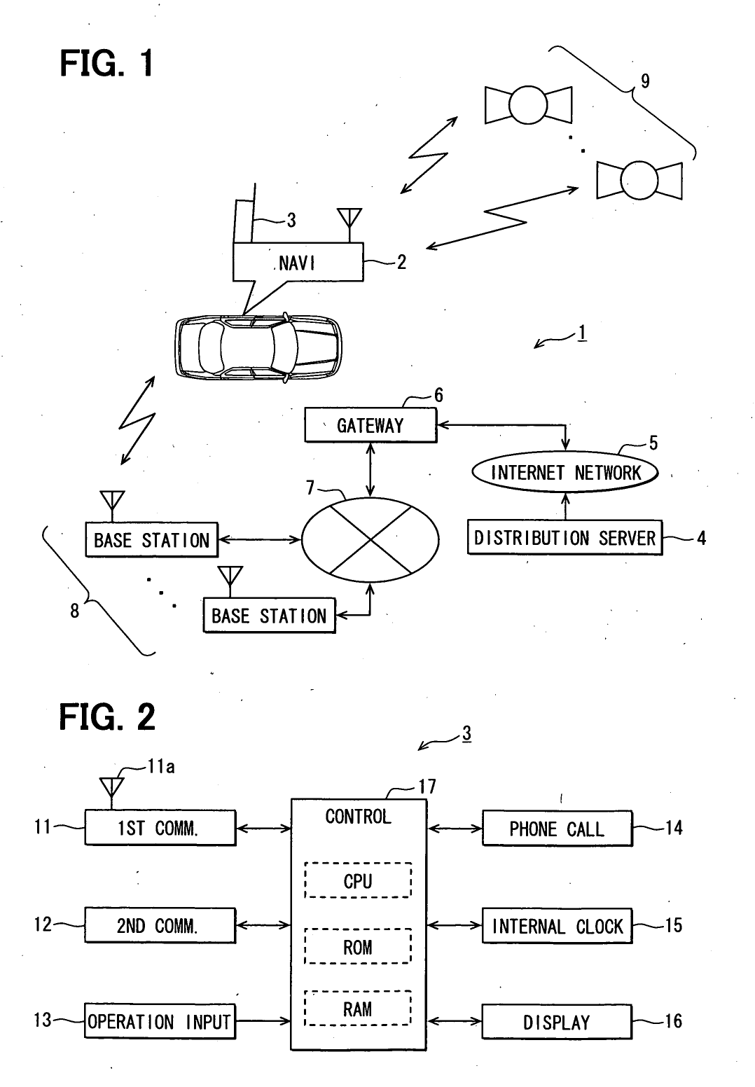

An overall configuration of a local time amendment system 1 using a local time amendment method according to an embodiment of the present invention is illustrated in FIG. 1.

The local time amendment system 1 includes a navigation apparatus 2 mounted in a subject vehicle;

a cellular phone 3, which is held by a driver of the vehicle and connected to the navigation apparatus 2; and a distribution server 4, which distributes local time information for indicating an exact local time for every administrative area such as a country, state, or city. Herein, the administrative area signifies a minimum unit of an area constituting a time zone associated with a time difference or enforcement of the daylight saving time. For example, in Japan or Europe, the administrative area corresponds to a country while in the United States of America or Australia, it corresponds to a city.

In the local time amendment system 1, the distribution server 4 is connected to base stations 8 via an Internet communication network 5, a gateway exchange 6, and a mobile radio communication network (e.g., cellular phone network) 7. The cellular phone 3 is connected wirelessly with the base station 8 to thereby communicate with the distribution server 4. The navigation apparatus 2 receives radio waves (namely, GPS signals) from a satellite 9 (also referred to as a GPS Satellite).

The gateway exchange 6 interconnects therebetween the Internet communication network 5 and the mobile radio communication network 7, which have different communication protocols from each other, to relay data exchange therebetween.

In contrast, the multiple base stations 8 are installed in the communication service area of the mobile radio communication network 7. Each base station 8 has or covers an individual communication area and wirelessly communicates with the cellular phone 3 within the communication area while continuously broadcasting in the communication area a wireless base station identification signal which includes a base station ID uniquely assigned to the base station 8.

When receiving an area checking signal (to be explained later) from the cellular phone 3, the base station 8 transmits the received signal to the distribution server 4. When receiving information on local time from the distribution server 4, the base station 8 transmits a control signal including the received information or contents to the cellular phone 3.

When receiving the area checking signal from the base station 8, the distribution server 4 designates as a transmission destination the cellular phone 3 based on the identification information contained in the received signal and transmits information on local time, to which a transmission code is added in order to designate the transmission destination, to the base station 8.

### <Configuration of Cellular Phone>

FIG. 2 is a block diagram illustrating an overall configuration of the cellular phone 3 according to the embodiment. The cellular phone 3 includes a first communication section 11 having an antenna 11a to thereby execute wireless communication with the base station 8; a second communication section 12 for executing wireless communication with the navigation apparatus 2 using a short range wireless technology, such as Bluetooth (registered trademark); an operation input section 13 for inputting numerals, characters, operation instructions, etc.; a phone call section 14 having a microphone, speaker, and voice processing circuit to thereby execute well-known call processing; an internal clock section 15 which counts a clock time; a liquid crystal display section 16 for displaying various images; and a control section 17. The control section 17 executes the various processes based on inputs of the foregoing components 11 to 15 and controls the first communication section 11, second communication section 12, phone call section 14, internal clock section 15, and liquid crystal display section 16.

Herein, the internal clock section 15 of the present embodiment is a type used for general cellular phones. The internal clock section 15 has an error of the counted clock time about one minute per one month. The first communication section 11 superimposes the data about the transmit voice, the data for packet communication, etc. on the carrier waves to thereby generate a transmission signal. The generated transmission signal is transmitted to the base station 8 via the antenna 11a. The wireless signal sent from the base station 8 is received via the antenna 11a. The received signal is demodulated to thereby obtain the data about the reception sound and the data for the packet communication addressed to the cellular phone 3.

The control section 17 includes a known microcomputer having a CPU, ROM, RAM, I/O, and a bus line connecting the foregoing components or the like. The ROM stores the various programs executed by the CPU and software programs of the operating system for the cellular phone 3, the Web (World Wide Web) browser, etc. In contrast, the RAM is used as a work area of the CPU and stores various kinds of data temporarily.

When receiving the base station identification signal via the first communication section 11 from the base station 8, the control section 17 (i.e., CPU) stores the present base station ID contained in the received signal. When the present base station ID is different from the base station ID previously stored in the RAM, the area checking signal containing the identification information (telephone number etc.) of the cellular phone 3 is transmitted to the base station 8 via the first communication section 11.

Furthermore, when receiving the control signal from the base station 8 via the first communication section 11, the control section 17 performs a process to amend the clock time counted by the internal clock section 15 to the accurate local time every administrative area based on the information on local time contained in the received signal. When receiving a demand signal (to be mentioned later) from the navigation apparatus 2 via the second communication section 12, the control section 17 transmits hour unit data for indicating the clock time indicated by the internal clock section 15 in units of hours to the navigation apparatus 2 via the second communication section 12.

<Configuration of Navigation Apparatus>

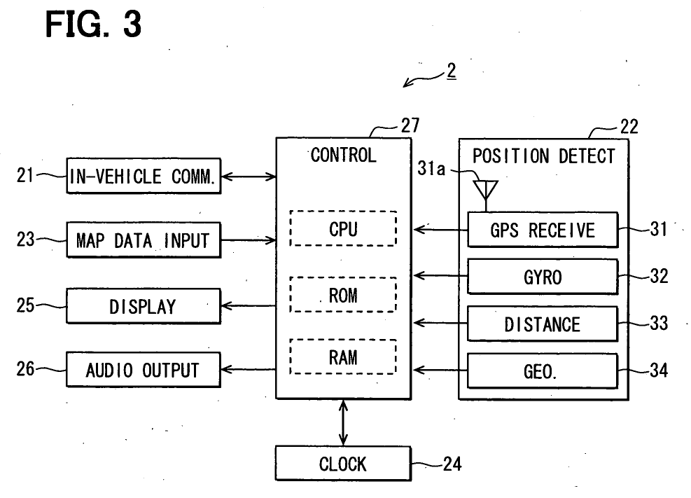

FIG. 3 is a block diagram illustrating an overall configuration of the navigation apparatus 2 according to the embodiment. The navigation apparatus 2 includes the followings: an in-vehicle communication section 21 for executing wireless communication with the cellular phone 3 using a short range wireless technology, such as Bluetooth (registered trademark); a position detection section 22 used for detecting a present position of the subject vehicle; the map data input section 23 for inputting map data; a clock section 24 (also referred to as a clock apparatus) for counting clock time based on the atomic clock of the GPS Satellite 9 mentioned above; a display section 25 for displaying various images; an audio output section 26 for outputting various kinds of guidance sounds; and a control section 27. The control section 27 performs various processes based on inputs from the foregoing components 21 to 24 and controls the in-vehicle communication section 21, clock section 24, display section 25, and audio output section 26.

The position detection section 22 includes the following: a GPS receiver 31 which receives the GPS signal via the GPS antenna 31a and outputs the received signal; a gyroscope 32 for detecting rotational movement exerted to the vehicle; a distance sensor 33 for detecting a travel distance from the acceleration or the like of the vehicle; and a geomagnetic sensor 34 for detecting a heading direction using the earth magnetism. These sensors 31 to 34 output respective detection signals for calculating a present position of the vehicle.

The map data input section 23 (not shown) is used for inputting various data such as map data and audio guidance data. The map data is stored in a rewritable map storage medium such as a hard disk or DVD-RAM. Herein, the map data according to the present embodiment contains borderline data showing the borderlines of the administrative areas mentioned above and administrative area IDs for identifying the administrative areas.

In addition, the display section 25 is a color display device, which can include any one of a well-known semi transmission type liquid crystal display, a general liquid crystal display, an organic electroluminescence display, a CRT, a head up display, etc.

The control section 27 includes a known microcomputer having a CPU, ROM, RAM, I/O, and a bus line connecting the foregoing components or the like. The RAM contains an ID storage area for storing or updating administrative area ID corresponding to the present position of the subject vehicle. Based on each detection signal inputted from the position detection section 22, the CPU performs a position calculation process to calculate a present position of the vehicle as a set of the coordinates and the heading direction. The CPU further performs a route guidance process to perform a route calculation to automatically retrieve an optimal route from the present position to a destination and execute route guidance based on the retrieved optimal route in the route calculation using the display section 25 and the audio output section 26. In addition, the administrative area ID according to the present position is calculated each time the position calculation process is executed. When the calculated administrative area ID is different from the administrative area ID previously stored in the ID storage area of the RAM, the ID storage area is updated.

In addition, based on the GPS signal inputted from the GPS receiver 31, the control section 27 (i.e., CPU) performs a GPS clock time amendment process to amend the clock time counted by the clock section 24 in units of minutes and seconds using the time of the world agreement (referred to as UTC (Universal Time Coordinated) clock time), which is obtained by inserting a leap second in the GPS time information (also referred to as hour, minute, and second information) contained in the GPS signal. The control section 27 further performs the following local time amendment process.

<Local Time Amendment Process>

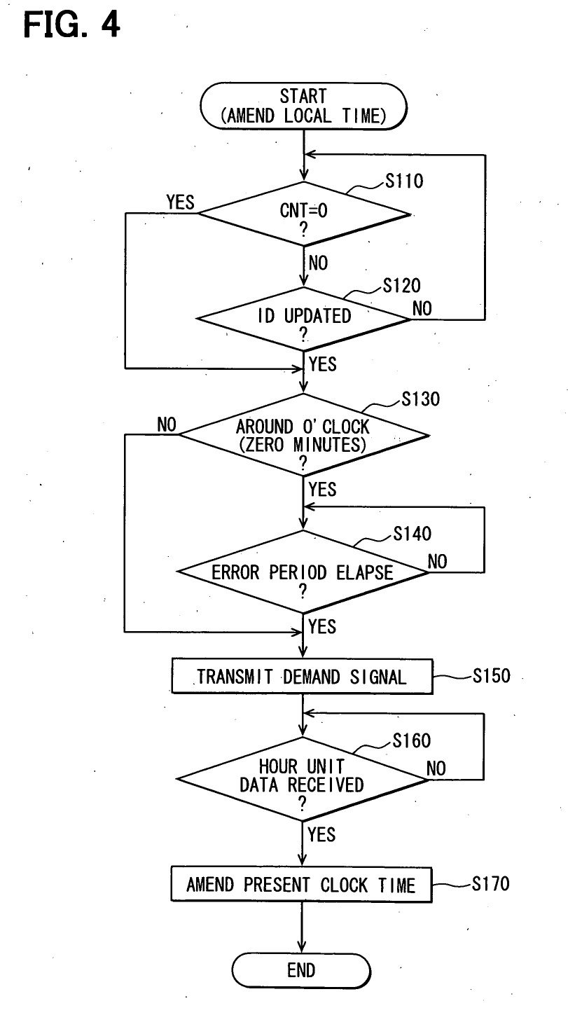

FIG. 4 is a flowchart diagram to illustrate a local time amendment process by the control section 27 of the navigation apparatus 2. In addition, the present process is started when the electric power is supplied to the navigation apparatus 2, and repeatedly executed thereafter. The present process is repeatedly executed in parallel with the position calculation process, the route guidance process, and the GPS time correction process until the supply of the electric power is stopped. In addition, the present process uses a process counter to update a counted value CNT each time the present process is started until the power supply is stopped.

First, as the present process is started, at S110, it is determined whether the counted value CNT of the process counter is set to an initial value of zero (0), namely, whether it is the first cycle after the electric power is supplied to the navigation apparatus 2. When the determination at S110 is affirmed, the processing proceeds to S130. When negated, it proceeds to S120.

At S120, it is determined whether the administrative area ID stored in the ID storage area of the RAM in the position calculation process is different from the administrative area ID previously stored in the ID storage area, namely whether the administrative area ID is newly updated. When the determination at S120 is affirmed, namely, when the subject vehicle goes across the borderline between the administrative areas, the processing proceeds to S130. When negated, it returns to S110.

At S130, it is determined whether the clock values indicating minutes and seconds in the counted clock time of the clock section 24 is within a predetermined range (e.g., two or three minutes) centered at 00 (zero) minutes (e.g., 12:00). When the determination at S130 is affirmed, the processing proceeds to S140. When negated, it proceeds to S150.

At S140, in order to absorb the error of the internal clock section 15 of the cellular phone 3, it is determined whether a predetermined error time period has elapsed. When the determination at S140 is affirmed, the processing proceeds to S150. When negated, the processing stands by until the error time period elapses. The internal clock section 15 of the cellular phone 3 has an error of about one minute per month; thus, the error time period in the present embodiment is predetermined to about ten minutes including a margin.

At S150, a demand signal is transmitted to the cellular phone 3 via the in-vehicle communication section 21 for acquiring hour unit data mentioned above. At S160, it is determined whether the hour unit data is received from the cellular phone 3 via the in-vehicle communication section 21. When the determination at S160 is affirmed, the processing proceeds to S170. When negated, the processing stands by until the hour unit data is received. Furthermore, when the hour unit data cannot be received within a predetermined time period, it is assumed that the power source of the cellular phone 3 is not turned on. The present process may be thus stopped promptly.

At S170, the present clock time counted by the clock section 24 is amended in units of hours based on the hour unit data received at S160. That is, the clock time of the clock section 24 is counted accurately by the units of minutes and seconds based on the UTC clock time; thus, the clock time of the clock section 24 is amended to the local time in the corresponding administrative area by matching only the hour unit of the clock time of the clock section 24 with the hour unit of the clock time indicated by the internal clock section 15 of the cellular phone 3. Furthermore, when the clock time of the clock section 24 is compared with the clock time indicated by the internal clock section 15 of the cellular phone 3 and the hour units of both the clock times are identical to each other, the present process may be stopped immediately.

Further, in the above embodiment, the GPS receiver 31 functions as an example of a GPS reception means or section. The map data input section 23 functions as an example of a map data input means. The position detection section 22 functions as an example of a position information acquisition means or section. The clock section 24 functions as an example of a clock means. The control section 27 functions as an example of an hour unit acquisition means or portion in S110 to S150. The control section 27 functions as an example of an amendment means or portion in S160 and S170.

(Effect)

As explained above, the local time amendment system 1 of the present embodiment operates as follows. The cellular phone 3 acquires the information on local time corresponding to the corresponding administrative area by the wireless communication via the base station 8. The hour unit data indicating the clock time in units of hours indicated by the internal clock section 15 of the cellular phone is acquired; then, the counted clock time of the clock section 24 is amended based on the acquired hour unit data.

Therefore, the local time amendment system 1 of the present embodiment does not require the configuration concerning the acquisition of the position information and the storage of the time difference (time coefficient) with the UTC clock time according to the position information. Furthermore, the local time amendment system 1 does not require an amendment process to add the time coefficient according to the position information to the counted clock time. The execution of the automatic correction of the local clock time can be thus allowed by the simple configuration and process.

In addition, in the navigation apparatus 2 of the present embodiment, the clock section 24 counts the accurate or exact clock time (Universal Time Coordinated or UTC clock time) based on the atomic clock of the GPS Satellite 9 in units of minutes and seconds while the data (e.g., hour unit data) indicating the local time in units of hours is acquired from the cellular phone 3. Thereby, the clock time counted by the clock section 24 can be automatically amended to the local time accurate in units of hours, minutes, and seconds.

Thus, according to the navigation apparatus 2 of the present embodiment, the automatic amendment of the clock time can be simply executed using the configuration of the existing apparatus and cellular phone system. Furthermore, the navigation apparatus 2 of the present embodiment is mounted in a subject vehicle. When the power source of the navigation apparatus 2 is switched on, or when the administrative area ID stored in the RAM is newly updated, the local time amendment process is configured to automatically amend the counted clock time to the local time.

Accordingly, the former case, namely, the case when the power source of the navigation apparatus 2 is switched on, is exemplified as the case that the vehicle is moved between the areas having a time difference therebetween by a car ferry or car train, or a case when a daylight saving time is started or enforced while the vehicle is not used for a long period of time. Even in such a case, when the vehicle is used, the automatic amendment of the clock time can be executed certainly. In addition, the latter case, namely, the case when the vehicle travels across a country borderline in Europe, a state borderline in Australia, or a city borderline in the United States, can be exemplified. Only in such a case, the automatic amendment of the clock time can be executed effectively.

(Other Embodiments)

Up to this point, description has been given to an embodiment of the present invention. However, the present invention is not limited to the above embodiment, and it can be variously embodied without departing from the subject matter of the present invention.

For example, the local time amendment process of the above embodiment is automatically started when the power source is supplied to the navigation apparatus 2. Without limitation to the above, another may be adopted. The switch for starting the amendment process may be provided for a driver or user to operate to select. In such case, if a user has a cellular phone which has no function of automatic amendment to the clock time based on information on local time, the switch of the cellular phone may be maintained turned off, thereby eliminating the need of executing unnecessary control.

Furthermore, the hour unit data is acquired from the cellular phone 3 by transmitting the demand signal in the local time amendment process of the above embodiment. Without being limited to the above, another procedure can be adopted. For instance, the cellular phone 3 may be configured to transmit the hour unit data to the navigation apparatus 2 after the cellular phone 3 transmits the area checking signal to the base station 8, namely, in case that the communication area changes.

In addition, in the local time amendment process of the above embodiment, the hour unit data is directly acquired from the cellular phone 3. Without being limited to the above, for example, clock information indicating the clock time in units of hours, minutes, and seconds of the internal clock section 15 of the cellular phone 3 may be acquired first; then, the hour unit data can be extracted from the acquired clock time in units of hours.

Furthermore, the local time amendment process of the above embodiment is ended when the present clock time counted by the clock section 24 is amended in units of hours based on the hour unit data. Without need to be limited to the above, the amended clock time of the clock section 24 may be transmitted to the cellular phone 3 to thereby amend the clock time of the internal clock section 15 of the cellular phone 3 to the exact time.

In addition, the cellular phone 3 of the above embodiment transmits the hour unit data to the navigation apparatus 2 immediately after receiving the demand signal from the navigation apparatus 2. Without need to be limited to the above, if the cellular phone 3 is under external communications such as a telephone call or transmission and reception of messages, the hour unit data may be transmitted after the external communication is completed.

Furthermore, the local time amendment system 1 of the above embodiment includes the navigation apparatus 2 mounted in the vehicle, the cellular phone 3 connected to the navigation apparatus 2, and the distribution server 4 to distribute the information on local time via the base station 8.

Without need to be limited to the above, for example, a wrist watch with the GPS function may be substituted for the navigation apparatus 2; otherwise, the information on local time may be distributed directly by the base station 8 instead of the distribution server 4. In addition, any receiver for receiving the control signal may be substituted for the cellular phone 3. The base station 8 may be replaced by a radio transmission tower which transmits the control signal by superimposing it on the FM multiplex broadcast etc.

Each or any combination of processes, steps, or means explained in the above can be achieved as a software portion or unit (e.g., subroutine) and/or a hardware portion or unit (e.g., circuit or integrated circuit), including or not including a function of a related device; furthermore, the hardware portion or unit can be constructed inside of a microcomputer.

Furthermore, the software portion or unit or any combinations of multiple software portions or units can be included in a software program, which can be contained in a computer-readable storage media or can be downloaded and installed in a computer via a communications network.

Aspects of the disclosure described herein are set out in the following clauses.

As a first aspect of the disclosure, a method is provided for amending a local time in a clock apparatus that counts a clock time based on information on hour, minute, and second included in a signal received from a satellite for a global positioning system. The method comprises: acquiring hour unit data representing, in units of hours, a clock time of a movement destination area indicated by an internal clock of a receiver, which has acquired a local time of a travel movement destination area by receiving a control signal, which is transmitted to the travel movement destination area; and amending, in units of hours, the clock time counted by the clock apparatus based on the acquired hour unit data to thereby amend the clock time, which is counted by the clock apparatus, to the local time of the travel movement destination area.

That is, in the present local time amendment method, the clock apparatus counts an accurate clock time, i.e., the UTC (Universal Time Coordinated) in units of minutes and seconds based on the radio waves from the GPS Satellite. The local time of the travel movement destination area is obtained in units of hours via the receiver. Thereby, the clock time of the clock apparatus is automatically amended to the local time accurate in units of hours, minutes, and seconds.

Therefore, the present local time amendment method does not require the configuration for acquiring position information and the configuration for storing the time difference (clock time coefficient) with the UTC according to the acquired position information. Furthermore, it does not require an amendment process to add the clock time coefficient according to the position information to the clock time of the clock apparatus. Such simple configuration and process can thus allow the execution of the automatic correction of the local clock time.

As an optional aspect, the receiver may be a cellular phone; further, the control signal may be transmitted from a base station, which is connected to a mobile radio communication network and covers the cellular phone.

According to the above local time amendment method, the local time is simply acquirable using the existing cellular phone system.

As a second aspect of the disclosure, a navigation apparatus is provided as follows. The navigation apparatus is mounted in a vehicle and communicates with a cellular phone. The navigation apparatus includes the following. A reception section is configured to receive a signal transmitted from a satellite for a global positioning system. A clock section is configured to count a clock time based on information on hours, minutes, and seconds included in the signal received by the reception section. An hour unit data acquisition portion is configured to acquire, at a predetermined acquisition time point, hour unit data representing in units of hours a clock time indicated by an internal clock of the cellular phone, which previously acquires a local time of a travel movement destination area wirelessly from a base station connected to a mobile radio communication network. An amendment portion is configured to amend, in units of hours, the clock time counted by the clock section based on the hour unit data acquired by the hour unit data acquisition portion.

Such configuration of the above navigation apparatus can provide an advantage similar to that of the method of the first aspect for amending a local time.

As an optional aspect, in the navigation apparatus, the acquisition time point may be a time point when the navigation apparatus is supplied with an electric power.

As an optional aspect, the navigation apparatus may further include a map data input section configured to input map data which is classified into every administrative area, and a position information acquisition section configured to acquire position information indicating a present position of the vehicle based on the signal received by the reception section and the map data inputted by the map data input section. Herein, the acquisition time point may be a time point when the present position of the vehicle goes across a borderline of each administrative area.

Further, as an optional aspect, in the navigation apparatus, in case that the clock time counted by the clock section is within a predetermined range centered at a clock time o'clock, the amendment portion may be further configured to designate, as the acquisition time point, a time point when a predetermined error time period elapses. Herein, the predetermined error time period is to absorb an error of the internal clock of the cellular phone.

For example, the above configuration can respond to the case when the local time is twelve o'clock sharp (i.e., exactly at 12:00) while the clock time of the cellular phone is eleven hours 59 minutes and 59 seconds (11:59:59), or the case when the local time is eleven 11 hours 59 minutes and 59 seconds (11:59:59) while the clock time of the cellular phone is twelve o'clock sharp (i.e., exactly at 12:00). Such cases can be prevented from undergoing mistakenly shifting of one hour in the local time amendment of the navigation apparatus.

It will be obvious to those skilled in the art that various changes may be made in the above-described embodiments of the present invention. However, the scope of the present invention should be determined by the following claims.

What is claimed is:

1. A method for amending a local time in a clock apparatus that counts a clock time based on information on hour, minute, and second included in a signal received from a satellite for a global positioning system,
the method comprising:
acquiring hour unit data representing, in units of hours, a clock time of a movement destination area indicated by an internal clock of a receiver, which has acquired a local time of a travel movement destination area by receiving a control signal, which is transmitted to the travel movement destination area; and
amending, in units of hours, the clock time counted by the clock apparatus based on the acquired hour unit data to thereby amend the clock time, which is counted by the clock apparatus, to the local time of the travel movement destination area.

2. The method according to claim 1, wherein:
the receiver includes a cellular phone; and
the control signal is transmitted from a base station, which is connected to a mobile radio communication network and covers the cellular phone.

3. A navigation apparatus that is provided in a vehicle and communicates with a cellular phone, the apparatus comprising:
a reception section configured to receive a signal transmitted from a satellite for a global positioning system;
a clock section configured to count a clock time based on information on hours, minutes, and seconds included in the signal received by the reception section;
an hour unit data acquisition portion configured to acquire, at a predetermined acquisition time point, hour unit data representing in units of hours a clock time indicated by an internal clock of the cellular phone, which previously acquires a local time of a travel movement destination area wirelessly from a base station connected to a mobile radio communication network; and
an amendment portion configured to amend, in units of hours, the clock time counted by the clock section based on the hour unit data acquired by the hour unit data acquisition portion.

4. The navigation apparatus according to claim 3, wherein
the acquisition time point includes a time point when the navigation apparatus is supplied with an electric power.

5. The navigation apparatus according to claim 3, further comprising:
a map data input section configured to input map data which is classified into every administrative area; and
a position information acquisition section configured to acquire position information indicating a present position of the vehicle based on the signal received by the reception section and the map data inputted by the map data input section,
wherein the acquisition time point is a time point when the present position of the vehicle goes across a borderline of each administrative area.

6. The navigation apparatus according to claim 3, wherein
in case that the clock time counted by the clock section is within a predetermined range centered at a clock time o'clock,
the amendment portion is further configured to designate, as the acquisition time point, a time point when a predetermined error time period elapses, the predetermined error time period absorbing an error of the internal clock of the cellular phone.
